(19) United States
(12) Patent Application Publication
(10) Pub. No.: US 2026/0127746 A1
(43) Pub. Date: May 7, 2026

(54) IMAGE MOTION ESTIMATION METHOD AND RELATED APPARATUS

(71) Applicant: Smarter Silicon (Shanghai) Technologies Co., Ltd., Shanghai (CN)

(72) Inventor: Wei CAO, Shanghai (CN)

(21) Appl. No.: 19/370,734

(22) Filed: Oct. 27, 2025

(30) Foreign Application Priority Data
Nov. 5, 2024 (CN) 202411571133.4

(51) Int. Cl. G06T 7/238; G06T 7/215; H04N 19/52; H04N 19/56

(52) U.S. Cl. CPC G06T 7/238; G06T 7/215; H04N 19/52; H04N 19/56; G06T 2207/10016; G06T 2207/20021; G06T 2207/20076

(57) ABSTRACT

An image motion estimation method includes obtaining motion vectors of an object in any two neighboring image frames in a video, obtaining a plurality of encoding blocks corresponding to the motion vectors of the object in the two neighboring image frames, dividing the encoding blocks to obtain a first prediction unit, performing motion search on pixels of the first prediction unit to obtain a first difference parameter set corresponding to the motion vectors of the first prediction unit, dividing the encoding blocks to obtain at least two second prediction units, performing motion search on pixels in the second prediction units for the encoding block based on the first difference parameter set to obtain a second difference parameter set of motion vectors of the second prediction units, and determining a target prediction unit based on the first difference parameter set and the second difference parameter set of each encoding block.

### CROSS-REFERENCES TO RELATED APPLICATION

This application claims priority to Chinese Patent Application No. 202411571133.4, filed on November 5, 2024, the entire content of which is incorporated herein by reference.

### FIELD OF TECHNOLOGY

The present disclosure relates to the information processing field and, more particularly, to an image movement estimation method and a related apparatus.

### BACKGROUND

Video compression can eliminate redundant video information in a time domain through inter prediction to improve compression efficiency. A current image macro block can be predicted by searching for a motion vector (i.e., MV) of an object in an image. The most suitable prediction unit can be found by traversing and partitioning the image macro block. The optimal block can be matched through a precise subpixel search to reduce residuals to save the bit-rate to be transmitted.

In some solutions, the image macro block is traversed and partitioned into four types of prediction units. FIG. 1 is a schematic diagram of the prediction units by dividing the image macro block. The prediction units can include 2N×2N, 2N×N, N×2N, and N×N, where N represents N pixels, and N is an integer.

For each motion vector in each prediction unit, a search is performed on the optimal subpixel MV (refined MV) based on a minimum SATD (Sum of Absolute Transformed Difference) cost (loss) principle. Then, for all motion vectors of each prediction unit, the top N subpixel MVs are selected based on the minimal SATD cost principle. From all prediction units, the top M prediction units are selected based on the minimal SATD cost principle. Finally, the top M optimal prediction units and the corresponding subpixel MVs are used as an output of the motion estimation.

However, to meet the encoding performance requirements, the processing time for each macro block (16×16) is less than 200 cycles. The searches for 2N×2N, 2N×N, and N×2N require processing the SATD calculation of nine points. The hardware resources are limited and become a performance bottleneck. Therefore, each prediction unit is usually restricted to processing at most two subpixel searches for MVs. However, the subpixel points of the current (PU, MV) may all be one of the optimal MVs. Due to the limitation on the number of MVs, the optimal MV may be missed, resulting in a loss in search precision to affect the compression efficiency.

### SUMMARY

One aspect of this disclosure provides an image motion estimation method. The method includes obtaining motion vectors of an object in any two neighboring image frames in a video, obtaining a plurality of encoding blocks corresponding to the motion vectors of the object in the two neighboring image frames, dividing the encoding blocks to obtain a first prediction unit, performing motion search on pixels of the first prediction unit for the encoding blocks based on the motion vectors of the object in the two neighboring image frames to obtain a first difference parameter set corresponding to the motion vectors of the first prediction unit, dividing the encoding blocks to obtain at least two second prediction units, performing motion search on pixels in the second prediction units for the encoding block based on the first difference parameter set to obtain a second difference parameter set of motion vectors of the second prediction units, storing a first difference parameter set and a second difference parameter set of each encoding block, and determining a target prediction unit based on the first difference parameter set and the second difference parameter set of each encoding block. Each first difference parameter corresponds to a motion vector difference of the two neighboring image frames in a pixel of the first prediction unit. The first prediction unit is obtained by dividing the encoding blocks in a first method. Each second motion vector corresponds to a motion vector difference of the two neighboring image frames in a pixel of the second prediction units. The second prediction units are obtained by dividing the encoding blocks in a second method. The second method is different from the first method. The target prediction unit is a prediction unit in a first image that matches motion of a second image. The first image is neighboring the second image and is generated later than the second image. A difference parameter of the target prediction unit is better than or smaller than a difference parameter of a non-target prediction unit.

Another aspect of this disclosure provides an electronic device, including one or more processors and one or more memories. The one or more memories store a computer program that, when executed by the one or more processors, causes the one or more processors to obtain motion vectors of an object in any two neighboring image frames in a video, obtain a plurality of encoding blocks corresponding to the motion vectors of the object in the two neighboring image frames, divide the encoding blocks to obtain a first prediction unit, and perform motion search on pixels of the first prediction unit for the encoding blocks based on the motion vectors of the object in the two neighboring image frames to obtain a first difference parameter set corresponding to the motion vectors of the first prediction unit, divide the encoding blocks to obtain at least two second prediction units, and perform motion search on pixels in the second prediction units for the encoding block based on the first difference parameter set to obtain a second difference parameter set of motion vectors of the second prediction units, store a first difference parameter set and a second difference parameter set of each encoding block, and determine a target prediction unit based on the first difference parameter set and the second difference parameter set of each encoding block. Each first difference parameter corresponds to a motion vector difference of the two neighboring image frames in a pixel of the first prediction unit. The first prediction unit is obtained by dividing the encoding blocks in a first method. Each second motion vector corresponds to a motion vector difference of the two neighboring image frames in a pixel of the second prediction units. The second prediction units are obtained by dividing the encoding blocks in a second method. The second method is different from the first method. The target prediction unit is a prediction unit in a first image that matches motion of a second image. The first image is neighboring the second image and is generated later than the second image. A difference parameter of the target prediction unit is better than or smaller than a difference parameter of a non-target prediction unit.

Another aspect of this disclosure provides a computer-readable storage medium storing a computer program that, when executed by the one or more processors, causes the one or more processors to obtain motion vectors of an object in any two neighboring image frames in a video, obtain a plurality of encoding blocks corresponding to the motion vectors of the object in the two neighboring image frames, divide the encoding blocks to obtain a first prediction unit, and perform motion search on pixels of the first prediction unit for the encoding blocks based on the motion vectors of the object in the two neighboring image frames to obtain a first difference parameter set corresponding to the motion vectors of the first prediction unit, divide the encoding blocks to obtain at least two second prediction units, and perform motion search on pixels in the second prediction units for the encoding block based on the first difference parameter set to obtain a second difference parameter set of motion vectors of the second prediction units, store a first difference parameter set and a second difference parameter set of each encoding block, and determine a target prediction unit based on the first difference parameter set and the second difference parameter set of each encoding block. Each first difference parameter corresponds to a motion vector difference of the two neighboring image frames in a pixel of the first prediction unit. The first prediction unit is obtained by dividing the encoding blocks in a first method. Each second motion vector corresponds to a motion vector difference of the two neighboring image frames in a pixel of the second prediction units. The second prediction units are obtained by dividing the encoding blocks in a second method. The second method is different from the first method. The target prediction unit is a prediction unit in a first image that matches motion of a second image. The first image is neighboring the second image and is generated later than the second image. A difference parameter of the target prediction unit is better than or smaller than a difference parameter of a non-target prediction unit.

### BRIEF DESCRIPTION OF THE DRAWINGS

In combination with accompanying drawings and with reference to the following description of embodiments, the above and other features, advantages, and aspects of the embodiments of the present disclosure will become more apparent. Throughout the drawings, a same or similar reference number represents a same or similar element. It should be understood that the drawings are schematic and that an element is not necessarily drawn to scale.

FIG. 1 is a schematic diagram of a prediction unit of an image macroblock division according to some embodiments of the present disclosure.

FIG. 2 is a schematic flowchart of an image movement estimation method according to some embodiments of the present disclosure.

FIG. 3 is a schematic flowchart of performing motion search on pixels of a first estimation unit for encoding blocks based on motion vectors of objects in two neighboring image frames to obtain a first difference parameter set corresponding to the motion vectors of the first estimation unit according to some embodiments of the present disclosure.

FIG. 4 is a schematic diagram showing a process of performing a search on the first estimation unit according to some embodiments of the present disclosure.

FIG. 5 is a schematic flowchart of dividing encoding blocks to obtain at least two second estimation units and performing a motion search on pixels of the second estimation unit for the encoding blocks to obtain s second difference parameter set of motion vectors of the second estimation unit according to embodiments of the present disclosure.

FIG. 6 is a schematic flowchart of determining an estimation unit corresponding to an optimal motion vector during a motion search process according to embodiments of the present disclosure.

FIG. 7 is a schematic flowchart of storing a first difference parameter set and a second difference parameter of each encoding block according to embodiments of the present disclosure.

FIG. 8 is a schematic flowchart of determining a target estimation unit of a plurality of encoding blocks based on a first difference parameter set and a second difference parameter set for each encoding block according to embodiments of the present disclosure.

FIG. 9 is a schematic structural diagram of an image movement estimation apparatus according to embodiments of the present disclosure.

FIG. 10 is a schematic structural diagram of a data storage module according to embodiments of the present disclosure.

FIG. 11 is a schematic structural diagram of another data storage module according to embodiments of the present disclosure.

FIG. 12 is a schematic diagram of an application scene of an image estimation method according to embodiments of the present disclosure.

FIG. 13 is a schematic structural diagram of an electronic device according to embodiments of the present disclosure.

### DETAILED DESCRIPTION

Embodiments of the present disclosure are described in detail in connection with embodiments of the present disclosure. The terms used in embodiments of the present disclosure are merely used to describe embodiments of the present disclosure rather than limit the present disclosure.

Embodiments of the present disclosure are described in connection with the accompanying drawings. Those of ordinary skill in the art can know that the technical solution of embodiments of the present disclosure can be suitable for similar technical problems as the technology develops and the new scene appears.

“First” and “Second” in the specification, claims, accompanying drawings of the present disclosure are used to distinguish objects and do not necessarily describe a specific order or sequence. Such terms can be interchanged where appropriate. This is merely a way to distinguish objects having the same properties in embodiments of the present disclosure. In addition, the terms “comprise,” “include,” and any of their variations, are intended to cover a non-exclusive inclusion, so that a process, method, system, product, or device that includes a series of elements is not limited to those elements, but may also include other elements not explicitly listed or inherent to such processes, methods, products, or devices.

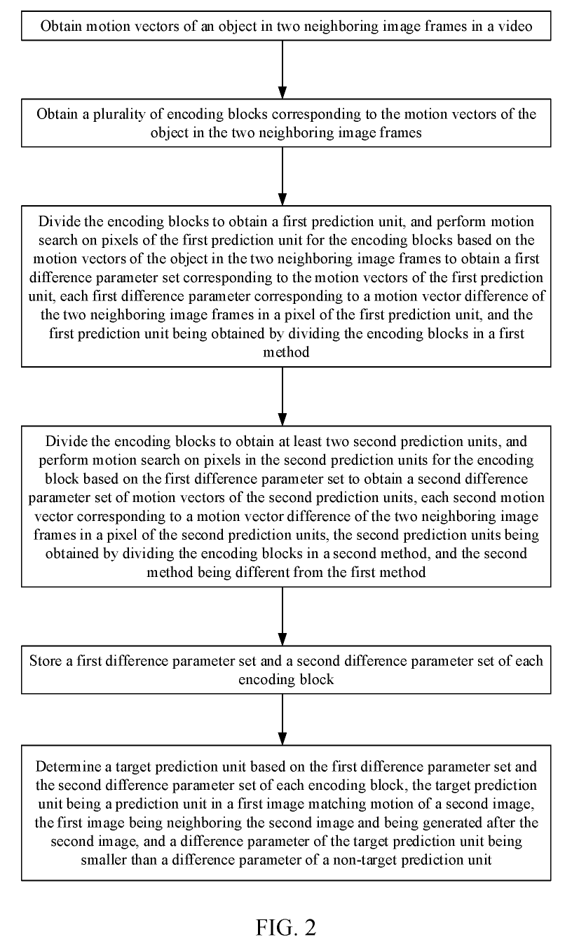

FIG. 2 is a schematic flowchart of an image movement estimation method according to some embodiments of the present disclosure. As shown in FIG. 2, an image motion estimation method of embodiments of the present disclosure includes steps 201 to 206, which are described in detail below.

At 201, a motion vector of an object of any two neighboring image frames in a video is obtained.

The motion vector can be an inter-frame motion vector hint mv.

The motion vector can include any one of temporal information (Temporal), spatial information (spatial), global quantity (global), constant (constant), or external information (external).

The motion vector of the object in the two image frames can include the same type of parameters or different types of parameters, which are not limited.

At 202, a plurality of encoding blocks corresponding to the motion vector of the object in any two neighboring image frames are obtained.

An encoding block can be a macro block. The two neighboring image frames can be divided into a plurality of macro blocks. The macro blocks can be used as the encoding blocks to provide a basis for a motion search of the motion vector.

At 203, the encoding blocks are divided into a first prediction unit. Based on the motion vector of the object in the two neighboring image frames, the motion search is performed on the pixels in the first prediction unit for the encoding blocks to obtain a first difference parameter set corresponding to the motion vector of the first prediction unit. Each first difference parameter corresponds to a motion vector difference of the two neighboring image frames of a pixel in the first prediction unit. The first prediction unit is obtained by dividing the encoding blocks in a first method.

The encoding block can be divided into prediction units (PU) according to different methods.

A plurality of motion vectors can exist in a same encoding block. With the motion vectors. The motion search can be performed on the pixels in the first prediction module for the encoding block to obtain the first difference parameter set corresponding to the motion vectors in the first prediction unit.

The first difference parameter set can include the result of performing the motion search on each pixel in the first prediction unit at a plurality of types of search precisions, which is the difference parameter of the plurality of types of search precisions.

The difference parameter of embodiments of the present disclosure can be represented by a SATD value.

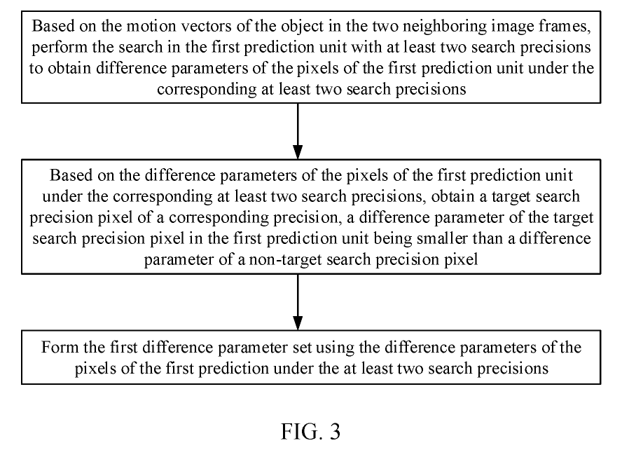

When the motion search is performed on the pixels of the first prediction unit for the encoding block, the search can be performed with a plurality of search precisions to obtain the corresponding difference parameters. The process of performing the motion search for the first prediction unit is described in detail in FIG. 3.

In some embodiments, a SATD value corresponding to each motion vector can be calculated for all the motion vectors in the first prediction unit.

The difference parameter can be the SATD value of the 4×4 blocks in the prediction units. Correspondingly, the difference parameter set can be a set of the SATD values of the 4×4 blocks in the corresponding prediction unit.

For the same motion vector and different prediction units, the difference parameter can be obtained by accumulating the SATD 4×4. The 4×4 can be the base unit of the Hadamard conversion in SATD. Thus, in the present disclosure, when the motion search is performed on the pixels of the first prediction unit, the plurality of search precisions can be adopted to record the difference parameters corresponding to the search precisions to provide a difference parameter basis for subsequently performing the motion search of the prediction unit obtained in other division methods.

At 204, the encoding blocks are divided to obtain at least two second prediction units. Based on the first difference parameter set, the motion search is performed on the pixels of the second prediction unit for the encoding blocks to obtain the second difference parameter set of the motion vectors in the second prediction unit. Each second motion vector parameter corresponds to the motion vector difference of the corresponding two neighboring image frames in one pixel of the second prediction unit. The second prediction unit is obtained by dividing the encoding blocks in the second method. The first method is different from the second method.

The encoding blocks can be divided to obtain a plurality of second prediction units. A second prediction unit can include other prediction units, excluding the first prediction unit, as divided in the first method.

In some embodiments, the number of the pixels in the first prediction unit can be larger than the number of the pixels of the second prediction unit.

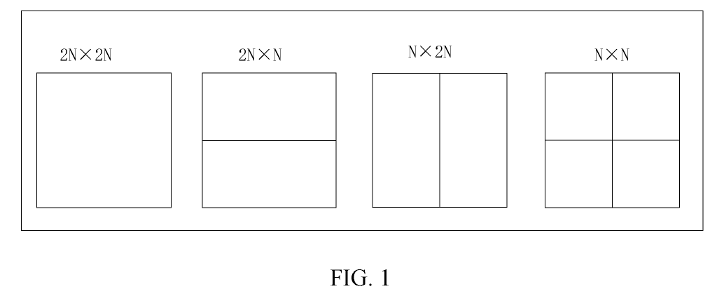

As shown in FIG. 1, the encoding blocks are divided to obtain the prediction units 2N×2N, 2N×N, N×2N, and N×N, where N represents N pixels and N is an integer.

The first method can be division according to 2N×2N, while the second method can be division according to N×2N, 2N×N, or N×N. Correspondingly, the first prediction unit can be a 2N×2N PU, and the second prediction unit can be an N×2N, 2N×N, or N×N PU.

When the motion search is performed on the pixels in the second prediction unit, the second difference parameter set of the second prediction unit can be obtained by using the difference parameter in the first difference parameter set obtained when the first prediction unit performs the motion search.

Since the corresponding difference parameter is obtained by performing the search with a plurality of types of search precisions when performing the motion search on the pixels of the first prediction unit, correspondingly, the difference parameter obtained by performing the search with the plurality of types of search precisions in the first prediction unit can be directly used when performing the motion search on the pixels in the second prediction unit, the search calculation may not need to be performed again.

In some embodiments, based on the correspondence between the pixels of the second prediction unit and the pixels of the first prediction unit, the second difference parameter set can be obtained by the cumulation based on the first difference parameter set. The process of obtaining the second difference parameter set is described in detail in FIG. 5.

The motion search can be performed on the pixels of the second prediction unit divided in the second method to obtain the corresponding second difference parameter set.

The second prediction unit obtained through the N×2N division can perform the motion search on the pixels of the second prediction unit to obtain a second difference parameter set of N×2N. The second prediction unit obtained through the 2N×N division can perform the motion search on the pixels of the second prediction unit to obtain a second difference parameter set of 2N×N. The second prediction unit obtained through the N×N division can perform the motion search on the pixels of the second prediction unit to obtain a second difference parameter set of N×N.

Since the SATD values of the same motion vector for different prediction units can be accumulated from SATD4×4, the calculation of SATD4×4 has already been performed for pixels with various search precisions when performing the motion search for the first prediction unit. Correspondingly, when the second prediction unit performs the motion search subsequently, the calculation can be directly performed based on the SATD4×4 obtained when the first prediction unit performs the search.

When the motion search is performed on the pixels in the second prediction unit, the motion search can be performed with a plurality of types of search precisions. The search process can be obtained based on the accumulation of the first difference parameter set of the first prediction unit, and the actual search calculation process may not need to be performed.

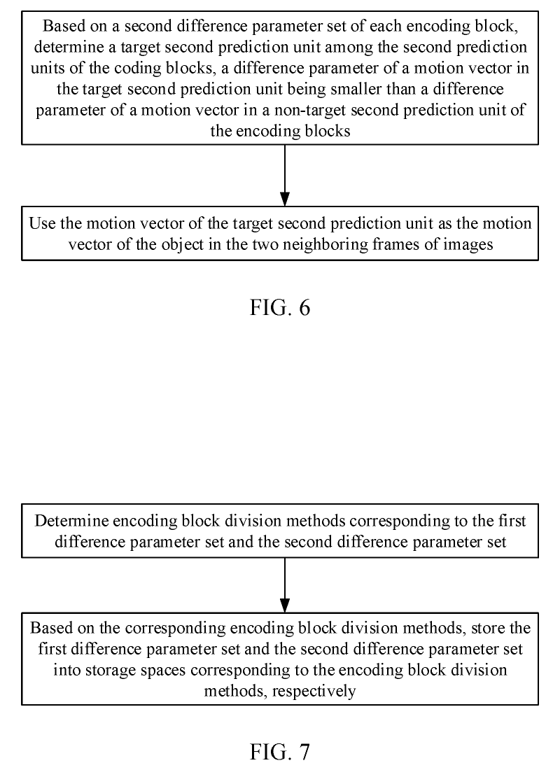

In some embodiments, when the motion search is performed on the pixels of the prediction units, the optimal motion vector of the encoding block can be determined based on the obtained difference parameter set. Then, the prediction unit with the optimal motion vector can be determined from the encoding block. The process of determining the prediction unit with the optical motion vector is described in detail in FIG. 6 for the motion search process.

At 205, the first difference parameter set and the second difference parameter set of each encoding block can be saved.

The first difference parameter set and the second difference parameter set obtained by performing the motion search on each encoding block can be saved, respectively.

In some embodiments, for different division methods, the difference parameter sets of the prediction units can be stored respectively. The storing process is described in detail in FIG. 7.

At 206, based on the first difference parameter set and the second difference parameter of each encoding block, the target prediction unit is determined. The target prediction unit is a prediction unit in the first image matched with the motion of the second image. The first image is neighboring the second image and is generated later than the second image. The difference parameter of the target prediction unit is better than or smaller than the difference parameter of the non-target prediction unit.

The plurality of prediction units can be obtained based on the plurality of division methods of each encoding block. The motion search with the plurality of search precisions can be performed on each prediction unit to obtain the difference parameter sets of the plurality of accuracies.

Accordingly, from the difference parameter sets obtained through the motion searches for the plurality of prediction units, the motion vector corresponding to the optimal difference parameter set of the prediction units can be determined. The target prediction unit can be determined according to the difference parameter sets. The target prediction unit can be the prediction unit of the first image matched with the motion of the second image. The difference parameter of the target prediction unit can be better than or smaller than the difference parameter of other prediction units.

In some embodiments, the target encoding block can be the target encoding block of the prediction unit having the optimal difference parameter.

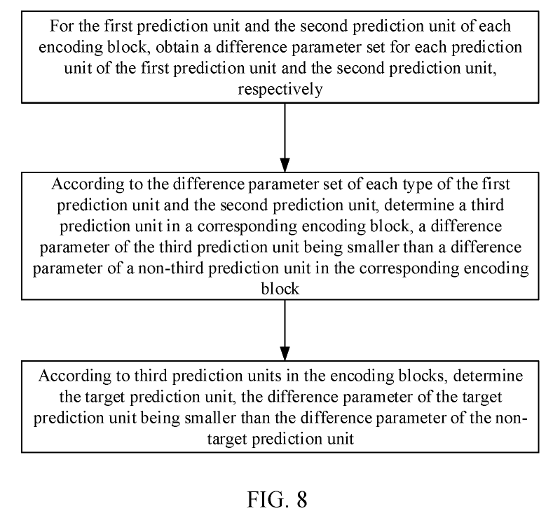

In some embodiments, the target prediction unit with the optimal difference parameter can be determined in the first image for the first different parameter set and the second difference parameter of each encoding block. The process of determining the target prediction unit is described in detail in FIG. 8.

After the target prediction unit is determined based on the above steps, image compression can be performed based on the target prediction unit.

Accordingly, the vector parameters of the target prediction unit can be used as the optimal vector parameters of the image frame. The image compression can be performed on the image according to the optimal vector parameter to reduce and compress the data amount and improve the compression efficiency.

In some embodiments, after obtaining the plurality of encoding blocks corresponding to the motion vectors of the objects in any two neighboring image frames, the encoding blocks can be divided in the first method to obtain the first prediction unit. Based on the motion vectors of the objects of the two neighboring image frames, the motion search can be performed on the pixels of the first prediction unit for the encoding blocks to obtain the first difference parameter set corresponding to the motion vectors in the first prediction unit. Then, when the motion search is performed on the pixels of the second prediction unit obtained by dividing the encoding blocks in the second method, the motion search can be performed according to the first difference parameter set to obtain the second difference parameter set corresponding to the motion vectors of the second prediction unit. The first difference parameter set and the second difference parameter set can be saved. The target prediction unit can be determined based on the first difference parameter set and the second difference parameter set of each encoding block. The target prediction unit can be the prediction unit in the first image that matches the motion of the second image. The difference parameter of the target prediction unit can be better than or smaller than the difference parameters of non-target prediction units in the first image. Thus, the data processing amount can be reduced when performing the motion search on the pixels in the second prediction unit. The actual search calculation may only be needed when the motion search is performed on the pixels of the first prediction unit to lower the data processing load of the overall image motion estimation process.

FIG. 3 is a schematic flowchart of performing motion search on pixels of a first estimation unit for encoding blocks based on motion vectors of objects in two neighboring image frames to obtain a first difference parameter set corresponding to the motion vectors of the first estimation unit according to some embodiments of the present disclosure. Steps 301 to 303 are described in detail below.

At 301, based on the motion vectors of the objects in the two neighboring image frames, search is performed in the first prediction unit with at least two search precisions to obtain the difference parameters of the pixels of the first prediction unit at the corresponding at least two search precisions.

In embodiments of the present disclosure, the motion search can be performed on the pixels of the first prediction unit for the encoding block.

When the motion search is performed on the pixels of any prediction units, a plurality of search precisions can be adopted. The types of the search precision can be determined as needed.

In the present disclosure, full-pixel search, 1/2-pixel search, and 1/4-pixel search can be taken as examples for explanation. In some embodiments, a higher motion accuracy can be adopted, e.g., 1/8-pixel search, which is not limited in the present disclosure.

For example, when the first prediction unit is 2N×2N, full-pixel search, 1/2-pixel search, and 1/4-pixel search can be performed on the pixels in the first prediction unit to obtain the difference parameters corresponding to each search precision accordingly.

During a 1/2-pixel search, interpolation is performed on the full pixels to obtain the motion vector of the 1/2 pixels. The difference parameter can be calculated based on the motion vectors of the 1/2 pixels. During a 1/4-pixel search, interpolation can be performed on the 1/2 pixels to obtain the motion vectors of the 1/4 pixels. The difference parameter can be calculated based on the motion vectors of the 1/4 pixels.

At 302, based on the difference parameters of the pixels of the first prediction unit at the at least two search precisions, the target search precision pixel is obtained with the corresponding accuracy. The difference parameter of the target search precision pixel of the first prediction unit is better than or smaller than the difference parameters of the non-target search precision pixels.

The first target search precision pixel can be determined based on the first search precision. The second target search precision pixel can be determined from the first target search precision pixel based on the second search precision. The second search precision and the first search precision can be two neighboring search precisions. The second search precision can be greater than the first search precision.

The search can be performed on the pixels of the first prediction unit with the determined search precisions sequentially to obtain the corresponding difference parameter.

After the difference parameter of the first prediction unit of a search precision is obtained, the target search precision pixel can be determined from the pixels of the first prediction unit according to the difference parameter. The difference parameter of the target search precision can be better than or smaller than the difference parameters of other pixels of the first prediction unit.

A plurality of target search precision pixels can be determined. The number of the target search precision pixels can be set as needed, which is not limited in the present disclosure.

When the search of a certain search precision is performed on the pixels of the first prediction unit, after the target search precision pixel with the corresponding accuracy is determined, based on the target search precision pixel, the search with a greater search precision can be performed on the target search precision pixel to obtain the target search precision pixel of the corresponding accuracy, and so on, until the largest search precision is reached to obtain the target pixel accuracy pixel of the largest search precision.

In some embodiments, the largest search precision can be set to the 1/4-pixel search. The full-pixel search can first be performed on all pixels of the first prediction unit to determine a set number of full pixels with the optimal SATD. Then, for the determined full pixels, the 1/2-pixel search can be performed to determine a set number of 1/2-pixels with the optimal SATD. Then, for the determined 1/2-pixels, the 1/4-pixel search can be performed to determine a set number of 1/4-pixels with the optimal SATD.

The full pixel can be a basic pixel unit in an image and can be used to describe a basic resolution of the image. The 1/2-pixel can be a smaller unit between full pixels. The 1/4-pixel can be a smaller unit between half-pixels, which is generally used in fine image processing operations such as motion estimation and interpolation calculation.

At 303, the difference parameters of the pixels in the first prediction unit of at least two search precisions can form the first difference parameter set.

The search with a plurality of search precisions can be performed on the pixels of the first prediction unit to obtain the difference parameter of the corresponding accuracy. The difference parameters of the search precisions can form the first difference parameter set.

In some embodiments, the difference parameters of the search precision pixels can be obtained. Accordingly, the difference parameters obtained for the search precisions can form sub-sets. The sub-sets can form the first difference parameter set.

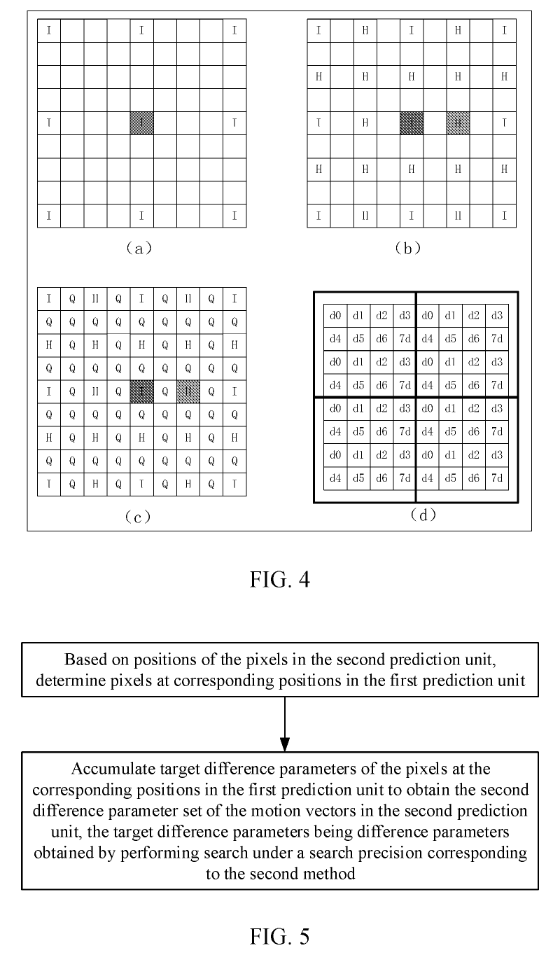

FIG. 4 is a schematic diagram showing a process of performing a search on the first estimation unit according to some embodiments of the present disclosure. The encoding block can be divided in the first division method to obtain the first prediction unit.

Wherein, (a) shows the full-pixel search for the first prediction unit. In the figure, I represents full pixels. The motion search is performed on the full pixels in the first prediction unit to obtain the corresponding SATD values. The optimal full pixel determined in (a) is marked in gray.

Wherein, (b) shows the 1/2-pixel search for the first prediction unit. In the figure, H represents 1/2 pixels. The 1/2 pixel is inserted between the full pixels. The motion search is performed for the 1/2-pixels to obtain the corresponding SATD values. A plurality of full pixels with small SATD cost can be determined. The 1/2 pixel research can be performed on the plurality of full pixels. The optimal 1/2 pixel determined in (b) is marked in gray.

Wherein, (c) shows the 1/4-pixel search for the first prediction unit. In the figure, Q represents 1/4-pixels. The 1/4 pixels can be inserted between 1/2-pixels. The motion search is performed for the 1/4-pixels to obtain the corresponding SATD values. After a plurality of 1/2 pixels with smaller SATD cost values are determined, the 1/4-pixel search is performed for the 1/2 pixels.

Wherein, (d) shows the motion vectors of the first prediction unit, that is the vector difference of corresponding pixel points of two images. Each grid is marked with dn (n ranging from 0 to 7), which represents the motion vector information of the corresponding pixel (full pixel, 1/ 2 pixel, and 1/4 pixel). In (d), each SATD4×4 is enclosed by a bolded frame in (d).

For the first prediction unit of 8×8, the SATD value of the first prediction unit can be obtained through the accumulation of each SATD4×4.

Since each prediction unit performs the search with a plurality of search precisions in different search methods, the difference parameters of the plurality of search precisions generated when the first prediction unit performs the search in the present disclosure can be directly used in the search process of the second prediction unit for the same search.

In some embodiments, to lower the data storage load, each calculated SATD4×4 value and the corresponding pixel location of the first prediction unit can be recorded. Then, when the motion search of the second prediction unit is performed, the SATD4×4 value and the corresponding pixel can be directly accumulated to obtain the difference parameter set.

In some embodiments, based on the motion vectors of the objects in the two neighboring image frames, the search can be performed in the first prediction unit under at least two types of search precisions to obtain the difference parameter of the pixels in the first prediction unit under the at least two search precisions. Based on the difference parameter of the pixels of the first prediction unit under the at least two search precisions, the target search precision pixel of the corresponding accuracy can be obtained. The difference parameter of the target search precision pixel of the first prediction unit can be better than or smaller than the difference parameter of the non-target search precision pixel. The difference parameters of the pixels of the first prediction unit of at least two corresponding search precisions can form the first difference parameter set. The first target search precision pixel can be determined based on the first search precision. The second target search precision pixel can be determined by performing the search on the first target search precision pixel based on the second search precision. The second search precision and the first search precision can be two neighboring search precisions. The second search precision can be greater than the first search precision. Then, the motion vector search with a plurality of search precisions can be performed on the pixels of the first prediction unit, and the difference parameter determined by the search can be stored, which provides the basis for the subsequent motion vector search of the second prediction unit.

FIG. 5 is a schematic flowchart of dividing encoding blocks to obtain at least two second prediction units and performing a motion search on the pixels of the second estimation unit for the encoding blocks to obtain the second difference parameter set of motion vectors of the second estimation unit according to embodiments of the present disclosure. Steps 501 and 502 are provided and described in detail below.

At 501, based on the positions of the pixels in the second prediction unit, the corresponding pixel positions in the first prediction unit are determined.

In the previous steps, the motion searches may be performed on the pixels in the first prediction unit to obtain the difference parameters of the pixels.

Since for the same motion vector, the SATD of different prediction units are obtained through the accumulation of the SATD4×4 values, when the motion search is performed for the first prediction unit, the calculation of the SATD4×4 may have been performed for different search precisions. Correspondingly, when the motion search is performed on the second prediction unit, the calculation can be directly performed based on the SATD4×4 obtained from the search for the first prediction unit.

The second prediction unit and the first prediction unit can belong to the same encoding block and can correspond to the same pixels.

Based on the positions of the pixels of the second prediction unit, the pixels at the corresponding positions in the first prediction unit can be determined.

As shown in FIG. 4, the second prediction unit includes some pixels of the first prediction unit. For example, the second prediction unit can be N×2N, and the pixels of the second prediction unit can be the left portion or the right portion of the first prediction unit. The pixels of the second prediction unit can overlap with the pixels in the first prediction unit.

At 502, based on the target difference parameters of the pixels at the corresponding positions in the first prediction unit, the second difference parameter set of the motion vectors of the second prediction unit is accumulated. The target difference parameter is the difference parameter obtained by performing the search under the search precision corresponding to the second method.

Based on the position correspondence between the second prediction unit and the first prediction unit, and the determined difference parameter of the first prediction unit, the target difference parameter corresponding to the second prediction unit can be determined.

Correspondingly, the target difference parameters corresponding to the second prediction unit can be accumulated to obtain the second difference parameters of the motion vectors.

In connection with (d) of FIG. 4, the corresponding SATD4×4 values are determined for the pixels at the corresponding positions in the second prediction unit. When the search is performed on the pixels in the second prediction unit, the SATD4×4 values included in the second prediction unit can be accumulated to obtain the second difference parameter set.

In some embodiments, 1/2-pixel search, 1/4-pixel search, etc., can be performed for the second prediction unit, and the search precisions can be consistent with the search precisions of the first prediction unit. The search precisions of the second prediction unit are not limited in the present disclosure.

In some embodiments, based on the positions of the pixels included in the second prediction unit, the pixels at the corresponding positions can be determined in the first prediction unit. Based on the target difference parameters of the pixels at the corresponding positions in the first prediction unit, the second difference parameter set of the motion vectors of the second prediction unit can be obtained through the accumulation. The target difference parameter can be the difference parameter obtained through the search with the search precision corresponding to the second method. Since the motion search is performed on the second prediction unit, the different parameters obtained by the first prediction unit can be directly used for calculation. The actual motion vector search calculation may not be needed, and the data processing load can be lowered.

FIG. 6 is a schematic flowchart of determining the prediction unit corresponding to an optimal motion vector during a motion search process according to embodiments of the present disclosure. Steps 601 and 602 are included and described in detail below.

At 601, based on the second difference parameter set of each encoding block, the target second prediction unit is determined from the second prediction units of the encoding blocks. The difference parameter of the motion vector in the target second prediction unit is better than or smaller than the difference parameter of the motion vector of the non-target second prediction unit.

Since the number of pixels included in the first prediction unit is the largest, the difference parameter of the motion vector of the second prediction unit can be worse. Thus, the optimal prediction unit can be determined merely for the second prediction units.

For each encoding block, the target second prediction unit can be determined. One or more target second prediction units can be provided.

For all the motion vectors in each second prediction unit, based on the minimal principle of SATD cost, and the second difference parameter set corresponding to the second prediction unit, a certain number of optimal sub-pixel motion vectors can be determined in each second prediction unit. In all the second prediction units, based on the minimal principle of SATD cost, a plurality of optical target second prediction units can be determined. The SATD costs of the target second prediction units can be calculated from a plurality of optimal second prediction units of all the second prediction units.

At 602, the motion vector of the target second prediction unit is used as the motion vector of the objects in the two neighboring image frames.

After the target second prediction unit is determined, the target second prediction unit can have the smallest SATD cost. Thus, the target second prediction unit can be the most similar in the two corresponding neighboring image frames. Correspondingly, the motion vector of the target second prediction unit can be optimal.

The motion vector of the target second prediction unit can be used as the motion vector of the objects corresponding to the two neighboring image frames.

In some embodiments, after the motion search is performed on the pixels of each prediction unit, according to the prediction unit whose encoding blocks have the second difference parameter set with the optimal difference parameter in the second prediction unit, the motion search can be performed on each prediction unit to determine a plurality of optimal prediction units.

FIG. 7 is a schematic flowchart of storing the first difference parameter set and the second difference parameter of each encoding block according to embodiments of the present disclosure. Steps 701 and 702 are provided and described in detail below.

At 701, the encoding block division methods corresponding to the first difference parameter set and the second difference parameter set are determined.

The encoding blocks can be divided in different division methods to obtain various prediction units. When the motion search is performed on the pixels of the prediction units, the difference parameter set corresponding to each prediction unit can be obtained.

The division method of the encoding blocks can include 2N×2N, 2N×N, N×2N, and N×N. Correspondingly, the motion search can be performed for each division method to obtain the corresponding difference parameter set.

For the first prediction unit 2N×2N, the motion search can be performed on the pixels in the prediction unit to obtain the first difference parameter set corresponding to the first prediction unit. The first difference parameter set can be stored.

For the second prediction unit 2N×N, the motion search can be performed on the pixels in the prediction unit to obtain the second difference parameter set corresponding to the second prediction unit. The second difference parameter set can be stored. For the second prediction unit N×2N, the motion search can be performed on the pixels in the prediction unit to obtain the second difference parameter set corresponding to the second prediction unit. The second difference parameter set can be stored. For the second prediction unit N×N, the motion search can be performed on the pixels in the prediction unit to obtain the second difference parameter set corresponding to the second prediction unit. The second difference parameter set can be stored.

With different division methods, different second prediction units can be obtained. Thus, in some embodiments, the encoding division method corresponding to the difference parameter sets can be pre-determined to realize the correspondence between the difference parameter sets and the prediction units.

At 702, based on the corresponding encoding block division method, the first difference parameter set and the second difference parameter set are stored in the storage spaces of the corresponding division methods, respectively.

In the storage area, individual storage spaces can be configured for the different encoding block methods.

Correspondingly, after the motion search is performed on any prediction unit to obtain the difference parameter set of the prediction unit, the difference parameter set can be stored in the corresponding storage space.

In some embodiments, when the search is performed for the first prediction unit 2N×2N, the first prediction unit usually cannot be determined as the target prediction unit. One of the second prediction units can be determined as the target prediction unit. Correspondingly, the first difference parameter set and the second difference parameter set may not be stored in the same storage area. Before the first difference parameter set is output to the storage space, the second difference parameter sets of the second prediction units can be directly calculated and stored in the storage area.

Correspondingly, in step 104, based on the first difference parameter set, the search process performed on the pixels of the second prediction unit for the encoding blocks can be simplified through the calculation based on the first difference parameter set and stored in the storage area.

In some embodiments, in the storage area, for different encoding block division methods, individual storage spaces can be configured. When the difference parameter set is received, for the encoding block division methods corresponding to the difference parameter sets, the difference parameter sets can be stored in the storage spaces corresponding to the division methods. Thus, the difference parameter sets of the different prediction units can be stored, respectively, to facilitate lookup.

FIG. 8 is a schematic flowchart of determining a target estimation unit of a plurality of encoding blocks based on a first difference parameter set and a second difference parameter set for each encoding block according to embodiments of the present disclosure. Steps 801 to 803 are included and described in detail below.

At 801, for the first prediction unit and the second prediction unit of each encoding block, the difference parameter sets of each type of prediction unit are obtained.

For the prediction units in the encoding blocks, the difference parameter sets of each type of prediction unit can be determined.

The difference parameters can be the SATD values of the 4×4 blocks of the prediction units. Correspondingly, the difference parameter set can be the set of the SATD values of the 4×4 blocks of the corresponding prediction units.

For the four forms of prediction units 2N×2N, 2N×N, N×2N, and N×N, the difference parameter sets corresponding to the prediction units can be obtained, respectively.

At 802, according to the difference parameter sets of each type of prediction unit, a third prediction unit is determined from the encoding block. The difference parameter of the third prediction unit is better than or smaller than the difference parameter of the non-third prediction unit in the encoding block.

In the encoding block, for the plurality of prediction units obtained by dividing the encoding block, the third prediction unit can be determined.

The difference parameter of the prediction unit can be obtained by performing the search on the pixels of the prediction unit under different search precisions.

In some embodiments, an optimal prediction unit can be searched based on the minimal SATD cost principle. The third prediction unit can be the prediction unit corresponding to the optimal sub-pixel.

When the difference parameter is smaller, the prediction unit can be more similar to the corresponding prediction unit in the last image frame.

At 803, according to the third prediction unit in the encoding block, the target prediction unit is determined. The difference parameter of the target prediction unit is better than or smaller than the difference parameter of the non-target prediction unit.

One image frame can be divided into a plurality of encoding blocks. The target prediction unit can be determined for the third prediction unit determined from the encoding blocks. The target prediction unit can be the prediction unit with the difference parameter better than or smaller than the difference parameter of the non-target prediction unit in the whole image frame.

The number of the target prediction units can be preset to m. m can be a positive integer. Correspondingly, m target prediction units can be determined from the one image frame.

One or more prediction units can be determined as the third prediction units for each encoding block to eventually determine the plurality of optical target prediction units.

The vector parameter of the target prediction unit can be used as an optimal vector parameter.

In some embodiments, for the first prediction unit and the second prediction unit of each encoding block, the difference parameter sets of each type of prediction unit can be obtained. According to the difference parameter sets of each type of prediction unit, the third prediction unit of the corresponding encoding block can be determined. The difference parameter of the third prediction unit can be better than or smaller than the difference parameter of the non-third prediction unit of the corresponding encoding block. According to the third prediction units of the encoding blocks, the target prediction unit can be determined. The difference parameter of the target prediction unit can be better than or smaller than the difference parameter of the non-target prediction unit. Thus, the third prediction unit with a better difference parameter can be determined through comparison in each encoding block first. Then, the comparison can be performed among the encoding blocks included in the whole image to determine the eventual target prediction unit to obtain the target prediction unit of the image.

The image motion estimation method of embodiments of the present disclosure is described above. The electronic device executing the image motion is described below. The electronic device can include an image motion estimation apparatus.

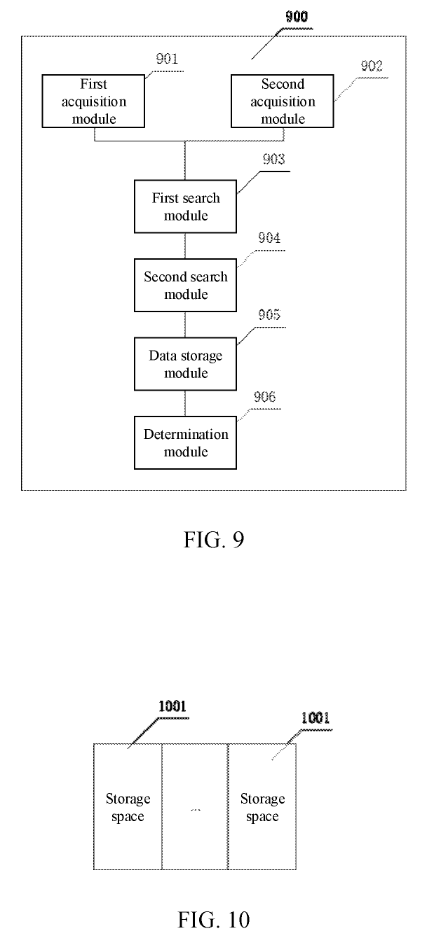

FIG. 9 is a schematic structural diagram of the image movement estimation apparatus 900 according to embodiments of the present disclosure.

The image motion estimation apparatus 900 includes a first acquisition module 901, a second acquisition module 902, a first search module 903, a second search module 904, a data storage module 905, and a determination module 906.

The first acquisition module 901 can be configured to obtain motion vectors of the objects in any two neighboring image frames.

The second acquisition module 902 can be configured to obtain a plurality of encoding blocks corresponding to the motion vectors of the objects in any two neighboring image frames.

The first search module 903 can be configured to divide the encoding blocks to obtain the first prediction units, and perform the motion search on the pixels of the first prediction units for the encoding blocks based on the motion vectors of the objects in the two neighboring image frames to obtain the first difference parameter sets corresponding to the motion vectors of the first prediction units. Each first difference parameter can correspond to the motion vector difference of one pixel of the first prediction unit of the two neighboring images. The first prediction unit can be obtained by dividing the encoding block in the first method.

The second search module 904 can be configured to divide the encoding blocks to obtain at least two second prediction units and perform motion search on the pixels of the second prediction units for the encoding blocks based on the first difference parameter set to obtain the second difference parameter sets of the motion vectors in the second prediction units. Each second motion vector parameter can correspond to the motion vector difference of one pixel in the second prediction unit of the two neighboring image frames. The second prediction units can be obtained by dividing the encoding blocks in the second method. The second method can be different from the first method.

The data storage module 905 can be configured to store the first difference parameter set and the second difference parameter set of each encoding block.

The determination module 906 can be configured to determine the target encoding block based on the first difference parameter set and the second difference parameter set of each encoding block. The target encoding block can be an encoding block in the first image, matching the motion of the second image. The first image and the second image can be neighboring each other. The first image can be generated later than the second image. The difference parameter of the target encoding block can be better than or smaller than the difference parameter of the non-target encoding block.

In some embodiments, the first search module can be configured to perform search in the first prediction unit with at least two search precisions based on the motion vectors of the objects in the two neighboring image frames to obtain the difference parameters of the pixels in the first prediction unit at the corresponding at least two search precisions, obtain the target search precision pixel with the corresponding accuracy based on the difference parameter of the pixels in the first prediction unit at the corresponding at least two search precisions, the difference parameter of the target search precision pixel in the first prediction unit being better than or smaller than the difference parameter of the non-target search precision pixels, and forming the difference parameters of the pixels in the first prediction unit at the corresponding at least two search precisions as the first difference parameter set.

The first target search precision pixels can be determined based on the first search precision. The second target search precision pixel can be determined through the search on the first target search precision pixels based on the second search precision. The second search precision and the first search precision can be two neighboring search precisions, and the second search precision can be greater than the first search precision.

In some embodiments, the number of pixels included in the first prediction unit can be greater than the number of pixels included in the second prediction unit.

In some embodiments, the image motion estimation module can further include a prediction unit determination module configured to determine the target second prediction unit from the second prediction units of the encoding blocks based on the second difference parameter set of each encoding block before storing the first difference parameter set and the second difference parameter set of each encoding block. The difference parameter of the motion vector of the target second prediction unit can be better than or smaller than the difference parameter of the motion vectors in the target second prediction unit can be better than or smaller than the difference parameter of the motion vectors of the non-target second prediction units in the encoding blocks. The motion vectors of the target second prediction unit can be used as the motion vectors of the objects in the two neighboring image frames.

In some embodiments, the determination module can be configured to obtain the difference parameter set of each prediction unit for the first prediction unit and the second prediction unit of each encoding block, determine the third prediction unit in the corresponding encoding block according to the difference parameter set of each prediction unit, the difference parameter of the third prediction unit being better than or smaller than the difference parameters of the non-third prediction units in the encoding block, and determine the target prediction unit according to the third prediction unit in the encoding block. The difference parameter of the target prediction unit can be better than or smaller than the difference parameter of the non-target prediction units.

FIG. 10 is a schematic structural diagram of a data storage module according to embodiments of the present disclosure. The data storage module includes at least two storage spaces 1001.

Each storage space can be configured to store difference parameters of a corresponding division method.

The storage space can correspond to a prediction unit corresponding to the division method. An individual storage space can be configured for the prediction units corresponding to each division method to store the difference parameter sets of the prediction units corresponding to the different division methods separately.

For example, corresponding storage spaces can be configured for 2N×2N, 2N×N, and N×2N, respectively.

In some embodiments, since 2N×2N is generally not selected as the target prediction unit, the storage space for storing the difference parameter set of the first prediction unit can be omitted, and the storage spaces can be configured only for the second prediction units.

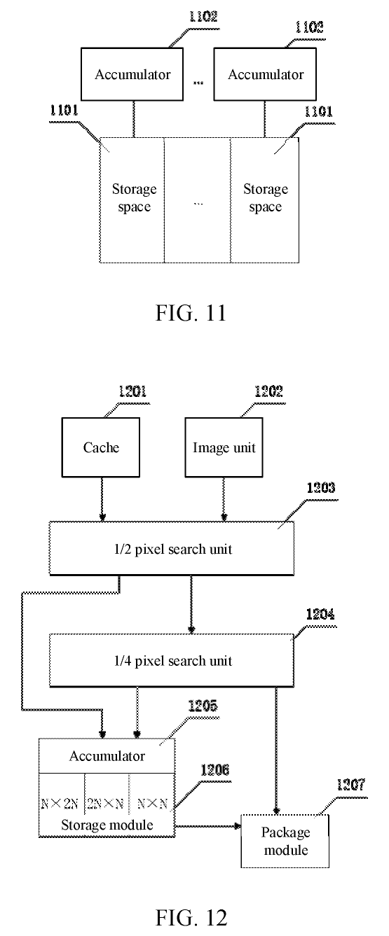

FIG. 11 is a schematic structural diagram of another data storage module according to embodiments of the present disclosure. The data storage module includes at least two storage spaces 1101 and at least two accumulators 1102.

One accumulator can correspond to one type of division method for an encoding block of the second prediction unit.

The accumulators can be configured to accumulate, for the positions of the pixels contained in the corresponding second prediction unit, the target difference parameters of the pixels at the corresponding positions in the first prediction unit to obtain the second difference parameter set of the motion vectors in the corresponding second prediction unit. The target difference parameter can be the difference parameter obtained by search with the precision corresponding to the second method.

In some embodiments, the search of the second search module can be directly obtained through the calculation of the accumulators and can be used as the search result of the second search module.

In some embodiments, the accumulator can be an ACC.

The accumulator can be a 16-bit SATD4×4-based accumulator. The storage space can include three 24bit×18×2 memories.

For the functional description of the structures of the image motion estimation apparatus of embodiments of the present disclosure, reference can be made to the description of the method above, which is not repeated here.

The image motion estimation apparatus can correspond to or be integrated into a video codec chip of an electronic device.

In the electronic device using the image motion estimation apparatus, when the video is transmitted, during the process of determining the target prediction unit using the image motion estimation apparatus, compared to the search calculations performed on the prediction units, the motion search calculation process may not be needed for the second prediction unit. Thus, the data processing load of the chip can be lowered, the device power consumption can be reduced, and the prediction unit with the optimal difference parameter can be accurately determined. The residual can be reduced when the video frame is compressed, the transmission bit rate can be saved, and the transmission efficiency can be improved.

In some embodiments, after the plurality of encoding blocks corresponding to the motion vectors of the objects in any two neighboring image frames, the encoding blocks can be divided in the first method to obtain the first prediction units. Based on the motion vectors of the object in the two neighboring image frames, the motion search can be performed on the pixels in the first prediction units of the encoding blocks to obtain the first difference parameter set corresponding to the motion vectors in the first prediction unit. The search can be performed according to the first difference parameter set to obtain the second difference parameter set corresponding to the motion vectors of the second prediction units. The first difference parameter set and the second difference parameter set can be stored. The target prediction unit can be determined based on the first difference parameter set and the second difference parameter set of each encoding block. The target prediction can be the prediction unit of the first image that matches the motion of the second image. The difference parameter of the target prediction can be better than or smaller than the difference parameter of non-target prediction units in the first image. The data processing amount of the motion search performed on the pixels of the second prediction unit can be reduced. The actual search calculation may only be performed on the motion search on the pixels of the first prediction unit. Thus, the data processing load of the whole image motion estimation process can be lowered.

FIG. 12 is a schematic diagram of an application scene of an image estimation method according to embodiments of the present disclosure. The application scene includes a cache 1201, an image unit 1202, a 1/2 pixel search unit 1203, a 1/4 pixel search unit 1204, an accumulator 1205, a storage module 1206, and a package module 1207.

The cache 1201 can be configured to store the plurality of prediction units obtained from division. The motion vector unit 1202 can be configured to store full pixel motion vectors mv of any of the two neighboring image frames.

The 1/2 pixel search unit can be configured to receive the full pixel motion vectors. To perform the 3×3 half-pixel search for each full pixel, the 4×4 SATD value included in the current prediction unit can be calculated. The motion vector mv of the optimal 1/2 pixel can be determined according to the minimal SATD principle.

The processed prediction unit can be 2N×2N, and the 4×4 SATD values interpolated and calculated by the 1/2-pixel search unit can be sent to the accumulator 1205. The accumulator 1205 can first perform accumulation on the SATD values corresponding to the 1/2 pixel to obtain the SATD values of the corresponding N×2N, 2N×N, and N×N. The obtained SATD values of the corresponding N×2N, 2N×N, and N×N can be stored in the corresponding storage spaces in the storage module 1206.

The 1/4 pixel search unit 1204 can perform the 1/4 pixel search on the motion vector optimized by the 1/2 pixel search to determine the motion vector mv of the optimal 1/4 pixel according to the minimal SATD principle.

The processed prediction unit can be 2N×2N. The 4×4 SATD values interpolated and calculated by the 1/4-pixel search unit can be sent to the accumulator 1205. The accumulator 1205 can perform the accumulation on the SATD values corresponding to the 1/4 pixel to obtain the SATD values of the corresponding N×2N, 2N×N, and N×N. The SATD values of the corresponding N×2N, 2N×N, and N×N can be stored in the corresponding storage spaces in the storage module 1206.

After the search is performed on the encoding blocks of the image, MVPACK phase can be performed. When the motion vectors of the prediction units are processed in sequence, a newly added motion vector and the corresponding SATD can be read from the corresponding storage space and inserted between the motion vectors through the normal search. The motion vectors can be sent to the subsequent selection strategy. The selection strategy can be rate-distortion optimization (RDO).

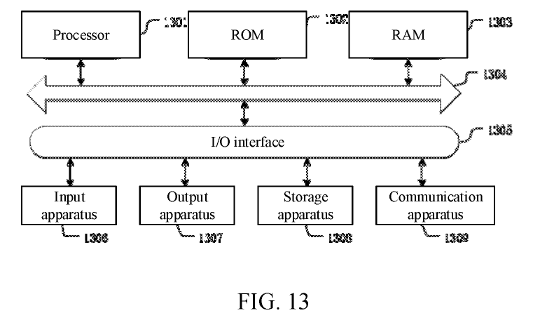

Embodiments of the present disclosure further provide an electronic device. FIG. 13 is a schematic structural diagram of the electronic device according to embodiments of the present disclosure. The electronic device of embodiments of the present disclosure can include, but is not limited to, fixed terminals such as mobile phones, notebook computers, PDAs (personal digital assistants), PADs (tablet computers), desktop computers, and so on. The electronic device shown in FIG. 13 is merely an example and should not impose any limitation on the functions and application scope of embodiments of the present disclosure.

As shown in FIG. 13, the electronic device includes a processing unit (e.g., a central processing unit (CPU), graphics processing unit (GPU), etc.) 1301. The processing unit 1301 can perform any suitable actions or processing according to the program stored in the ROM 1302 or the program loaded into the RAM 1303 from the storage apparatus 1308. When the electronic device is powered on, various programs and data needed for the operations of the electronic device can be further stored in the RAM 1303. The processing unit 1301, the ROM 1302, and the RAM 1303 are interconnected with each other through a bus 1304. The I/O interface 1305 is also connected to the bus 1304.

In general, an input apparatus 1306, such as a touchscreen, touchpad, keyboard, mouse, camera, microphone, accelerometer, gyroscope, etc., an output apparatus 1307, such as a liquid crystal display (LCD), speaker, vibrator, etc., a storage apparatus 1308, such as a memory card, hard disk, etc., and a communication apparatus 1309 can be connected to the I/O interface 1305. The communication apparatus 1309 can allow the electronic device to perform wireless or wired communication with other devices to exchange data. Although FIG. 13 shows the electronic device including various apparatuses, the electronic device is not required to include all the apparatuses shown in FIG. 13 during implementation. The electronic device can include more or fewer apparatuses, or different apparatuses.

Embodiments of the present disclosure further provide a computer-readable storage medium. The storage medium stores one or more computer programs that, when executed by the electronic device, cause the electronic device to implement any one of the image motion estimation methods of embodiments of the present disclosure.

The above-described apparatus embodiments are merely exemplary. The units described as separate components may or may not be physically separated. The components displayed as units may or may not be physical units. That is, the components can be located in one place or distributed across a plurality of network units. Some or all of the components can be selected to implement the solutions of embodiments of the present disclosure as needed. In addition, in the accompanying drawings of the apparatus embodiments of the present disclosure, the connection relationship between the modules can represent the communication connections among them, which can be one or more communication buses or signal lines.

Through the description of the above implementations, those skilled in the art can understand that the present disclosure can be implemented with the help of software plus necessary general hardware, and of course, through dedicated hardware including dedicated integrated circuits, dedicated CPUs, dedicated memories, dedicated components, etc. In general, any function performed by a computer program can be easily implemented by corresponding hardware. Moreover, the specific hardware structure configured to implement the same function can also be diverse, such as analog circuits, digital circuits, or special circuits. However, in the present disclosure, a software program can be a better implementation method. Based on this understanding, the technical solution of the present disclosure, or the part that contributes to the prior art, can be embodied in the form of a software product. This computer software product can be stored in a readable storage medium, such as a computer floppy disk, USB flash drive, mobile hard disk, ROM, RAM, magnetic disk or optical disk, etc., and includes a number of instructions for enabling a computer device (e.g., a personal computer, training device, or network device, etc.) to execute the methods of embodiments of the present disclosure.

Embodiments of the present disclosure can be all or partially implemented by software, hardware, firmware, or any combination thereof. When embodiments of the present disclosure are implemented by software, the embodiments of the present disclosure can be all or partially implemented as a computer program product.

The computer program product can include one or more computer instructions. When the computer program is loaded and executed on the computer, all or a part of the processes or functions of embodiments of the present disclosure can be generated. The computer can include a general-purpose computer, a special-purpose computer, a computer network, or other programmable apparatus. The computer instructions can be stored in a computer-readable storage medium or transmitted from one computer-readable storage medium to another computer-readable storage medium. For example, the computer instruction can be transmitted from one network station, computer, training device, or data center to another network station, computer, training device, or data center via wired (e.g., coaxial cable, optical fiber, digital subscriber line (DSL)) or wireless (e.g., infrared, wireless, microwave, etc.) means. The computer-readable storage medium can be any available medium capable of storing data on a computer, or a data storage device such as a training device, data center, or other integrated device that includes one or more available media. The computer-readable storage medium can be magnetic media (e.g., floppy disks, hard disks, magnetic tapes), optical media (e.g., DVDs), or semiconductor media (e.g., solid-state disks (SSD)), and so on.

What is claimed is:

1. An image motion estimation method comprising:
obtaining motion vectors of an object in two neighboring image frames in a video;
obtaining a plurality of encoding blocks corresponding to the motion vectors of the object in the two neighboring image frames;
dividing the encoding blocks to obtain a first prediction unit, and performing motion search on pixels of the first prediction unit for the encoding blocks based on the motion vectors of the object in the two neighboring image frames to obtain a first difference parameter set corresponding to the motion vectors of the first prediction unit, each first difference parameter corresponding to a motion vector difference of the two neighboring image frames in a pixel of the first prediction unit, and the first prediction unit being obtained by dividing the encoding blocks in a first method;
dividing the encoding blocks to obtain at least two second prediction units, and performing motion search on pixels in the second prediction units for the encoding block based on the first difference parameter set to obtain a second difference parameter set of motion vectors of the second prediction units, each second motion vector corresponding to a motion vector difference of the two neighboring image frames in a pixel of the second prediction units, the second prediction units being obtained by dividing the encoding blocks in a second method, and the second method being different from the first method;
storing a first difference parameter set and a second difference parameter set of each encoding block; and
determining a target prediction unit based on the first difference parameter set and the second difference parameter set of each encoding block, the target prediction unit being a prediction unit in a first image matching motion of a second image, the first image being neighboring the second image and being generated after the second image, and a difference parameter of the target prediction unit being smaller than a difference parameter of a non-target prediction unit.

2. The image motion estimation method according to claim 1, wherein
performing the motion search on the pixels of the first prediction unit for the encoding blocks based on the motion vectors of the object in the two neighboring image frames to obtain the first difference parameter set corresponding to the motion vectors of the first prediction unit includes:
based on the motion vectors of the object in the two neighboring image frames, performing the search in the first prediction unit with at least two search precisions to obtain difference parameters of the pixels of the first prediction unit under the corresponding at least two search precisions;
based on the difference parameters of the pixels of the first prediction unit under the corresponding at least two search precisions, obtaining a target search precision pixel of a corresponding precision, a difference parameter of the target search precision pixel in the first prediction unit being smaller than a difference parameter of a non-target search precision pixel; and
forming the first difference parameter set using the difference parameters of the pixels of the first prediction under the at least two search precisions;
wherein:
a first target search precision pixel is determined based on a first search precision;
a second target search precision pixel is determined based on a second search precision; and
the second search precision is neighboring to and greater than the first search precision.

3. The image motion estimation method according to claim 1, wherein dividing the encoding blocks to obtain the at least two second prediction units, and performing the motion search on pixels in the second prediction units for the encoding blocks based on the first difference parameter set to obtain the second difference parameter set of the motion vectors of the second prediction units includes:
based on positions of the pixels in the second prediction unit, determining pixels at corresponding positions in the first prediction unit; and
accumulating target difference parameters of the pixels at the corresponding positions in the first prediction unit to obtain the second difference parameter set of the motion vectors in the second prediction unit, the target difference parameters being difference parameters obtained by performing search under a search precision corresponding to the second method.

4. The image motion estimation method according to claim 1, wherein
a number of pixels contained in the first prediction unit is greater than a number of pixels contained in any one second prediction unit of the at least two second prediction units.

5. The image motion estimation method according to claim 1, further comprising, before storing the first difference parameter set and the second difference parameter set of each coding block:
based on a second difference parameter set of each encoding block, determining a target second prediction unit among the second prediction units of the coding blocks, a difference parameter of a motion vector in the target second prediction unit being smaller than a difference parameter of a motion vector in a non-target second prediction unit of the encoding blocks; and
using the motion vector of the target second prediction unit as the motion vector of the object in the two neighboring frames of images.

6. The image motion estimation method according to claim 1, wherein storing the first difference parameter set and the second difference parameter set of each encoding block includes:
determining encoding block division methods corresponding to the first difference parameter set and the second difference parameter set; and
based on the corresponding encoding block division methods, storing the first difference parameter set and the second difference parameter set into storage spaces corresponding to the encoding block division methods, respectively.

7. The image motion estimation method according to claim 6, wherein
based on the first difference parameter set and the second difference parameter set of each encoding block, determining the target prediction unit includes:
for the first prediction unit and the second prediction unit of each encoding block, obtaining a difference parameter set for each prediction unit of the first prediction unit and the second prediction unit, respectively;
according to the difference parameter set of each type of the first prediction unit and the second prediction unit, determining a third prediction unit in a corresponding encoding block, a difference parameter of the third prediction unit being smaller than a difference parameter of a non-third prediction unit in the corresponding encoding block; and
according to third prediction units in the encoding blocks, determining the target prediction unit, the difference parameter of the target prediction unit being smaller than the difference parameter of the non-target prediction unit.

8. An electronic device comprising:
one or more processors; and
one or more memories storing a computer program that, when executed by the one or more processors, causes the one or more processors to:
obtain motion vectors of an object in any two neighboring image frames in a video;
obtain a plurality of encoding blocks corresponding to the motion vectors of the object in the two neighboring image frames;
divide the encoding blocks to obtain a first prediction unit, and perform motion search on pixels of the first prediction unit for the encoding blocks based on the motion vectors of the object in the two neighboring image frames to obtain a first difference parameter set corresponding to the motion vectors of the first prediction unit, each first difference parameter corresponding to a motion vector difference of the two neighboring image frames in a pixel of the first prediction unit, and the first prediction unit being obtained by dividing the encoding blocks in a first method;
divide the encoding blocks to obtain at least two second prediction units, and perform motion search on pixels in the second prediction units for the encoding block based on the first difference parameter set to obtain a second difference parameter set of motion vectors of the second prediction units, each second motion vector corresponding to a motion vector difference of the two neighboring image frames in a pixel of the second prediction units, the second prediction units being obtained by dividing the encoding blocks in a second method, and the second method being different from the first method;
store a first difference parameter set and a second difference parameter set of each encoding block; and
determine a target prediction unit based on the first difference parameter set and the second difference parameter set of each encoding block, the target prediction unit being a prediction unit in a first image matching motion of a second image, the first image being neighboring the second image and being generated after the second image, and a difference parameter of the target prediction unit being smaller than a difference parameter of a non-target prediction unit.

9. The device according to claim 8, wherein the one or more processors are further configured to:
based on the motion vectors of the object in the two neighboring image frames, perform the search in the first prediction unit with at least two search precisions to obtain difference parameters of the pixels of the first prediction unit under the corresponding at least two search precisions;
based on the difference parameters of the pixels of the first prediction unit under the corresponding at least two search precisions, obtain a target search precision pixel of a corresponding precision, a difference parameter of the target search precision pixel in the first prediction unit being smaller than a difference parameter of a non-target search precision pixel; and
form the first difference parameter set using the difference parameters of the pixels of the first prediction under the at least two search precisions;
wherein:
a first target search precision pixel is determined based on a first search precision;
a second target search precision pixel is determined based on a second search precision; and
the second search precision is neighboring to and greater than the first search precision.

10. The device according to claim 8, wherein the one or more processors are further configured to:
based on positions of the pixels in the second prediction unit, determine pixels at corresponding positions in the first prediction unit; and
accumulate target difference parameters of the pixels at the corresponding positions in the first prediction unit to obtain the second difference parameter set of the motion vectors in the second prediction unit, the target difference parameters being difference parameters obtained by performing search under a search precision corresponding to the second method.

11. The device according to claim 8, wherein a number of pixels contained in the first prediction unit is greater than a number of pixels contained in any one second prediction unit of the at least two second prediction units.

12. The device according to claim 8, wherein the one or more processors are further configured to:
based on a second difference parameter set of each encoding block, determine a target second prediction unit among the second prediction units of the coding blocks, a difference parameter of a motion vector in the target second prediction unit being smaller than a difference parameter of a motion vector in a non-target second prediction unit of the encoding blocks; and
use the motion vector of the target second prediction unit as the motion vector of the object in the two neighboring frames of images.

13. The device according to claim 8, wherein the one or more processors are further configured to:
determine encoding block division methods corresponding to the first difference parameter set and the second difference parameter set; and
based on the corresponding encoding block division methods, store the first difference parameter set and the second difference parameter set into storage spaces corresponding to the encoding block division methods, respectively.

14. The device according to claim 13, wherein the one or more processors are further configured to:
for the first prediction unit and the second prediction unit of each encoding block, obtain a difference parameter set for each prediction unit of the first prediction unit and the second prediction unit, respectively;
according to the difference parameter set of each type of the first prediction unit and the second prediction unit, determine a third prediction unit in a corresponding encoding block, a difference parameter of the third prediction unit being smaller than a difference parameter of a non-third prediction unit in the corresponding encoding block; and
according to third prediction units in the encoding blocks, determine the target prediction unit, the difference parameter of the target prediction unit being smaller than the difference parameter of the non-target prediction unit.

15. A computer-readable storage medium storing a computer program that, when executed by one or more processors, causes the one or more processors to:
obtain motion vectors of an object in any two neighboring image frames in a video;
obtain a plurality of encoding blocks corresponding to the motion vectors of the object in the two neighboring image frames;
divide the encoding blocks to obtain a first prediction unit, and perform motion search on pixels of the first prediction unit for the encoding blocks based on the motion vectors of the object in the two neighboring image frames to obtain a first difference parameter set corresponding to the motion vectors of the first prediction unit, each first difference parameter corresponding to a motion vector difference of the two neighboring image frames in a pixel of the first prediction unit, and the first prediction unit being obtained by dividing the encoding blocks in a first method;
divide the encoding blocks to obtain at least two second prediction units, and perform motion search on pixels in the second prediction units for the encoding block based on the first difference parameter set to obtain a second difference parameter set of motion vectors of the second prediction units, each second motion vector corresponding to a motion vector difference of the two neighboring image frames in a pixel of the second prediction units, the second prediction units being obtained by dividing the encoding blocks in a second method, and the second method being different from the first method;
store a first difference parameter set and a second difference parameter set of each encoding block; and
determine a target prediction unit based on the first difference parameter set and the second difference parameter set of each encoding block, the target prediction unit being a prediction unit in a first image matching motion of a second image, the first image being neighboring the second image and being generated after the second image, and a difference parameter of the target prediction unit being smaller than a difference parameter of a non-target prediction unit.

16. The computer-readable storage medium according to claim 15, wherein the one or more processors are further configured to:
based on the motion vectors of the object in the two neighboring image frames, perform the search in the first prediction unit with at least two search precisions to obtain difference parameters of the pixels of the first prediction unit under the corresponding at least two search precisions;
based on the difference parameters of the pixels of the first prediction unit under the corresponding at least two search precisions, obtain a target search precision pixel of a corresponding precision, a difference parameter of the target search precision pixel in the first prediction unit being smaller than a difference parameter of a non-target search precision pixel; and
form the first difference parameter set using the difference parameters of the pixels of the first prediction under the at least two search precisions;
wherein:
a first target search precision pixel is determined based on a first search precision;
a second target search precision pixel is determined based on a second search precision; and
the second search precision is neighboring to and greater than the first search precision.

17. The computer-readable storage medium according to claim 15, wherein the one or more processors are further configured to:
based on positions of the pixels in the second prediction unit, determine pixels at corresponding positions in the first prediction unit; and
accumulate target difference parameters of the pixels at the corresponding positions in the first prediction unit to obtain the second difference parameter set of the motion vectors in the second prediction unit, the target difference parameters being difference parameters obtained by performing search under a search precision corresponding to the second method.

18. The computer-readable storage medium according to claim 15, wherein a number of pixels contained in the first prediction unit is greater than a number of pixels contained in any one second prediction unit of the at least two second prediction units.

19. The computer-readable storage medium according to claim 15, wherein the one or more processors are further configured to:
based on a second difference parameter set of each encoding block, determine a target second prediction unit among the second prediction units of the coding blocks, a difference parameter of a motion vector in the target second prediction unit being better than or smaller than a difference parameter of a motion vector in a non-target second prediction unit of the encoding blocks; and
use the motion vector of the target second prediction unit as the motion vector of the object in the two neighboring frames of images.

20. The computer-readable storage medium according to claim 15, wherein the one or more processors are further configured to:
determine encoding block division methods corresponding to the first difference parameter set and the second difference parameter set; and
based on the corresponding encoding block division methods, store the first difference parameter set and the second difference parameter set into storage spaces corresponding to the encoding block division methods, respectively.
